(19) United States
(12) Patent Application Publication
(10) Pub. No.: US 2010/0169239 A1
(43) Pub. Date: Jul. 1, 2010

(54) METHOD FOR PRODUCTS RE-PRICING

(75) Inventors: Kuo-Hsiung Weng, San Jose, CA (US); Henry Chang, Taipei City (TW)

Correspondence Address: SCHMEISER OLSEN & WATTS, 18 E UNIVERSITY DRIVE, SUITE # 101, MESA, AZ, 85201, US

(73) Assignee: LEAD DIGI CORP., San Jose, CA (US)

(21) Appl. No.: 12/347,448

(22) Filed: Dec. 31, 2008

(51) Int. Cl. G06Q 10/00; G06N 5/02

(52) U.S. Cl. 705/400; 706/52; 706/47

(57) ABSTRACT

How to determine the price of a product, which includes any goods or services, is always a challenge task. One of the reasons is the difficulty of finding the prices of competitive products. Thus, most companies simply calculate the price by adding a markup to the cost. The markup is determined by experience, which could be inaccurate, or after an extensively manual survey of the prices of competitive products, which is time-consuming. The present invention allows sellers to automatically determine the price of a product by comparing the competitive products searched from the Internet.

### BACKGROUND OF THE INVENTION

1. Field of the Invention

The present invention relates to methods for calculating a product's price. More particularly, it relates to the methods of determining the most competitive price for a product. The process of determining the price takes into consideration both the seller and buyer's expectations towards a particular product. The expectations are formulated as static rules and dynamic rules.

2. Description of the Prior Art

The goal of re-pricing is to maximize the profit margin. However, it is always a challenging task to determine the price of a product, including any goods or services. One of the reasons is the difficulty in finding the information about competitive sellers and the prices of competing products. Traditionally, most companies simply calculate the price by adding a markup to the cost. The markup is determined by experience or after an extensive manual survey of the prices of competing products.

In Internet era, the information of competing sellers and their products, including the prices of the products, can be done automatically by using tools like Google search engine. Existing re-pricing methods usually apply certain rules to process the information to select competing sellers and to set the final price. Sample rules shown below were obtained from the website http://www.channelmax.net/CMaxAmazonRepricer.aspx as of Nov. 11, 2008 referring to FIG. 1.
Mark up the price by a certain percent or amount.
If you are the only seller set the price to your base price.
Re-price only if you gain a notch in rating system.
Ignore sellers with customer feedback rating lower than certain value.
Ignore pre-defined list of sellers.
Compete with only pre-defined list of sellers
Take average price of N sellers.

These methods have several deficiencies:
They only apply static rules in selecting competing sellers and setting the final price. Thus, the evaluation process of competing sellers is to answer a sequence of yes/no questions. For example, is this seller in a predefined list of sellers? If the answer is yes, then the seller will be considered further, otherwise, it is dropped.
They don't fully consider customers' expectation which may be in conflict with the seller's expectation. For example, the customers expect that the price of a product is as low as possible while the sellers expect that the price is as high as possible. Also, most existing methods do not consider “number of reviewers” and “the page where a product show on the search result” are some of the factors in a customer's decision in selecting a product.
They don't consider different factors in the evaluation process. For example, some customers may consider a product's price as more important than the feedback rating of the seller of the product. Some customers may consider feedback rating as more important than price.

### SUMMARY OF THE INVENTION

The present invention provides sellers a re-pricing approach which dynamically collects the prices of competing products and the information of the competitors, and then calculates the price of a seller's products by taking the following factors into consideration:

The customer's expectations

Online shopping customers usually buy a product from a seller based on the following criteria:
1. The price of the product is as low as possible.
2. The feedback rating given by the reviewer to the seller of the product is as high as possible.
3. The number of reviewers to the seller of the product is as high as possible.
4. The product appears in the search results as early as possible.

The seller's expectations

1. The price markup is as high as possible.

2. The minimum profit is maintained.

3. A pre-defined list of competitors is excluded.

4. A pre-defined list of competitors is included.

5. If I am the only seller, I would set the price to my base price.

Referring to FIG. 2, it is the summary of the procedure conducted by the present invention to re-price a product:
Step 1: Searching all the competing sellers
   Using Google search engine to search similar products sold by other sellers. FIG. 3 is an example of the result of searching “Apple iPod Classic 160 GB (Black)” in Google Product search engine (http://www.google.com/products).
Step 2: Applying static rules to exclude unqualified competing sellers
   This step is to apply certain rules to exclude unqualified competitive sellers. Sample rules are:
   Ignore sellers with customer feedback rating lower than a certain number
   Ignore pre-defined list of sellers.
   Compete with only pre-defined list of sellers.

The rules are considered static because the answers to these rules are only yes or no. For example, if the answer to the question “Is seller A included in a predefined list?” is no, then seller A is excluded.
Step 3: Applying dynamic rules to select the most competitive product
   The competing sellers found by a search engine usually provide the following information which can be used to determine the competitiveness of their products.
   Price of the products
   For example, as shown in FIG. 3, the price 3 of the first product 2 is $372.49. From a customer's perspective, the price of a product should be as low as possible.
   Feedback rating to the sellers
   For example, as shown in FIG. 3 the feedback rating 4 of the seller of the first product is 4.5. From a customer's perspective, the feedback rating to a seller should be as high as possible.
   Number of the reviewers of the sellers
   For example, as shown in FIG. 3 the number of the reviewers 5 of the first product is 29. From a customer's perspective, the number of reviewers of a seller should be as high as possible.
   The page where a product is displayed in the search result
   For example, the products in FIG. 3 are shown on page 2 of the search result page 6. The page number is determined on the basis of the following observation:
   1. Google product search engine displays the search results 10 products per page, and
   2. the sequence numbers 9 of the products displayed in FIG. 3 is between 11 and 20 (see Result 11-20 in FIG. 3)

Customers usually only select products, which are shown on the first few pages of the search result.

After comparing the parameters, we can select the most competitive seller The product of the seller is called the most competitive product in the present invention. The price of the most competitive product is called the most competitive price. The most competitive price is used as a reference to determine your product's price.
Step 4: Determining the upper limit of your product's price
   This step is to calculate the upper limit of your product's price by comparing the price of the most competitive product found from Step A.
Step 5: determining the lower limit of your price
   This step is to calculate the lower limit of your product's price, i.e., the minimum price you are willing to offer.
Step 6: Determining the markdown price of the most competitive product.

This step is to determine how much less you are going to charge for your product in order to be competitive to the most competitive product. This step is necessary if price is an important factor for customer's decision of buying your product.
Step 7: Compute the price of your product
   This step is to compute the price of your product.

### BRIEF DESCRIPTION OF THE DRAWINGS

FIG. 1 is the prior art of sample rules from http://www.channelmax.net/CMaxAmazonRepricer.aspx.

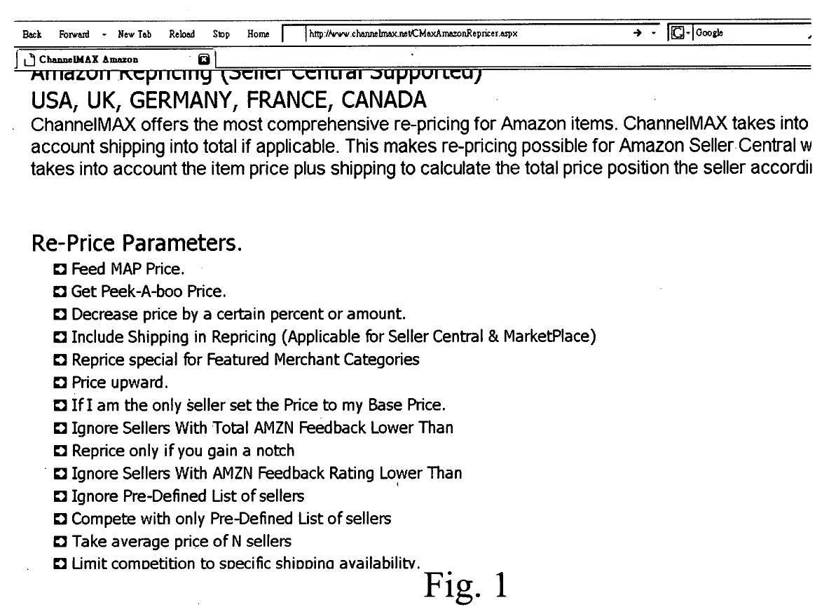

FIG. 2 is the method flow chart for products re-pricing.

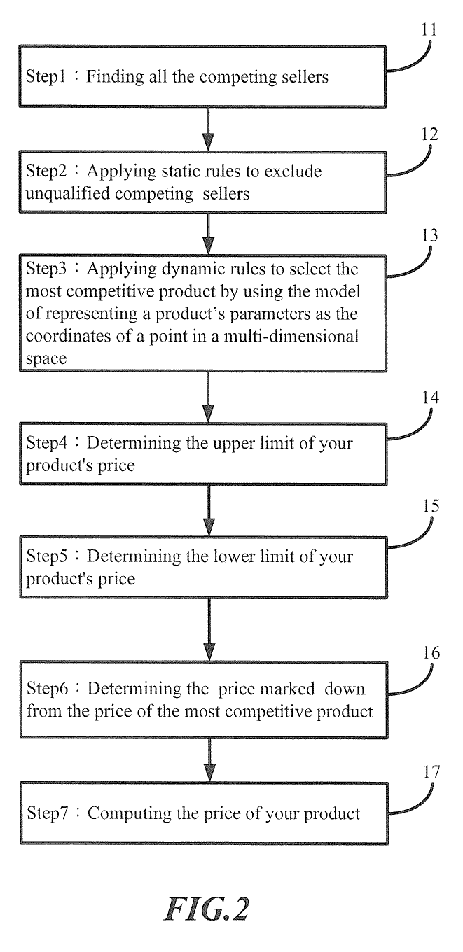

FIG. 3 is the search result of the product listed on Google product website.

FIG. 4 is the multidimensional product parameter space graph.

FIG. 5 is the Euclidean Distance information from http://en.wikipedia.org/wiki/Euclidean_distance

FIG. 6 is the Minkowski distance information from http://en.wikipedia.org/wiki/Distance

### DESCRIPTION OF THE PREFERRED EMBODIMENT

Although the following detailed description contains many specifics for the purposes of illustration, anyone of ordinary skill in the art will appreciate that many variations and alterations to the following details are within the scope of the invention. Accordingly, the following preferred embodiment of the invention is set forth without any loss of generality to, and without imposing limitations upon, the claimed invention.

The present invention automatically determines the price of a product by comparing the prices of the competitive products searched from Internet.

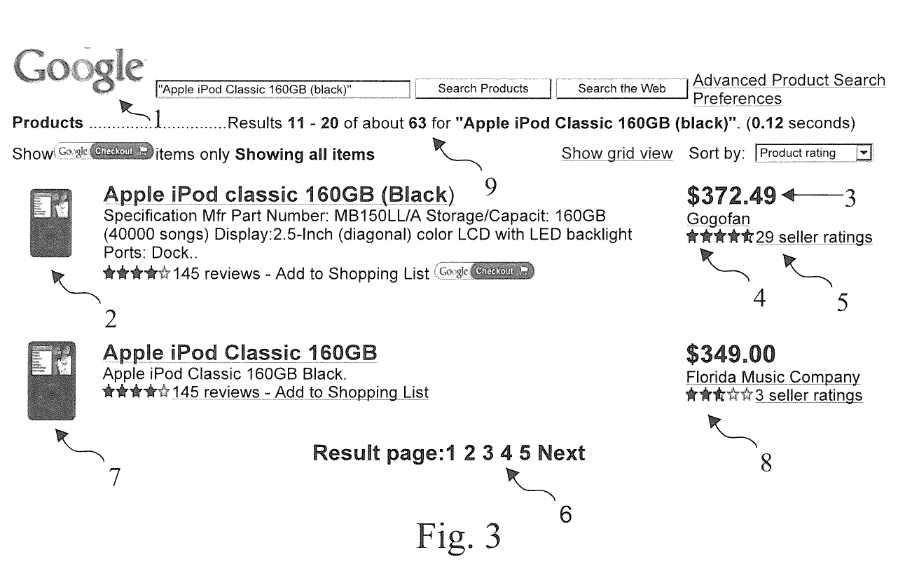

The following table is sample data collected from Google Product search in order to describe the concept of the current invention. Referring to FIG. 3, taking the seller 2 listed on the Google Product as an example, the number 6 refers to the page number where the product is displayed. Number 3 refers to the price offered by the seller. Number 4 refers to the feedback rating from consumers. Number 5 refers to the number of reviewers. FIG. 3 is organized in a list as in Table 1.

TABLE 1
Sample data collected from Google Product search

| | The page where | | | |
|---|---|---|---|---|
| | the product is | | | |
| | displayed in the | | Feedback | Number of |
| Seller | search result | Price | rating | reviewers |
| A | 1 | 372.49 | 4.5 | 30 |
| B | 2 | 378.99 | 4.5 | 40 |
| C | 3 | 375.95 | 3.5 | 35 |
| D | 4 | 380.40 | 4 | 45 |
| E | 5 | 365.00 | 2.5 | 37 |

The present invention provides a system and method for re-pricing a product, that overcomes the limitations of the prior art. The method is comprised of:

Input
Parameters related to your products.
   Cost of your product. (YC)
(This is usually the product's price given by the supplier of the product.)
   Markup percentage of your product (MU)
(The markup price generally refers to the profit margin the seller expects to make. The markup percentage is defined as

(1+profit percentage)
For example, if the profit percentage of a product is 10% of the cost of the product, then the markup percentage is 110%.)
   Markdown percentage of your product (MD)
(How much price markdown you are willing to do to the price of the most competitive product so that your product can outsell the most competitive one. The markdown percentage is defined as

(1−Price Discount Percentage)
For example, if your product is to be sold 10% cheaper than the most competitive product, then the markdown percentage is 90%.)
Parameters related to your company
   Feedback rating of your company (YR)
   Number of reviewers of your company (YNR)
Other parameters
   Weight i. (Wi)
(This is a value between 0 and 1. This value is the weight of a parameter taken into consideration in determining the price of the most competitive product. Sample weights are shown as follows:
   The weight of the inverse price (WICP)
   The inverse price of a price P for product Q is defined as maximum price minus price P. (Maximum−P)
   Maximum price is defined as the most expensive price of the same product Q sold by competing sellers.
   The weight of a seller's rating (WAR)
   The weight of the number of ratings to a seller (WNR)
   The weight of the inverse of the page where a product is shown on a search result. The inverse page of a product is defined as maximum page minus the page number where the product is shown on the search result. (WSP)
   (e.g. maximum page number−the page number where the product shows on the search result)
   For example, if a product is listed as the 15th item in a search result which finds 45 items, and the search engine shows 10 items per page, then
   i. maximum page number=45%10+1=5
   (“x % y” is defined as the integer portion of x/y.)
   For example: 45%/10=4, 45%/5=9
   ii. the page number where the product is shown on the search result 15%×10+1=2
   iii. the inverse page=5−2=3

Step A: Process of determining the price of the most competitive product
Step 1: Finding the information of competing sellers and their products from several major web sites providing product searching tools, such as Google, Yahoo, Microsoft, or Amazon, etc. FIG. 3 is an example of the result of searching the product, “Apple iPod Classic 160 GB (Black),” at the website, http://www.google.com/products. Usually the following data can be found from a search result:
   The price of a competitive product i (CPi)
   For example, the price of the first product 2 shown in FIG. 3 is $372.49.
   The feedback rating to the seller of the competitive product i. For example, the rating of the seller 4 of the first product shown in FIG. 3 is 4.5. (ARi)
   The number of ratings to the seller of the competitive product i For example, the number of the rating 5 to the seller of the first product shown in FIG. 3 is 29. (NRi)
   The page where the product i shows on the search result. (SPi)
Step 2: Applying static rules to exclude the unqualified competing sellers, the resulting sellers are defined as “candidate sellers.”
Some sellers are excluded because they cannot meet certain requirements. For example, product 7 in FIG. 3 will be removed if this rule is applied.
The sellers whose feedback rating is lower than 3.0 is also ignored.
The resulting candidate sellers are shown as follows:

TABLE 2
The data of Candidate Sellers

| | The page where the | | | |
|---|---|---|---|---|
| | product is displayed | | Feedback | Number of |
| Seller | in the search result | Price | rating | reviewers |
| A | 1 | 372.49 | 4.5 | 30 |
| B | 2 | 378.99 | 4.5 | 40 |
| C | 3 | 375.95 | 3.5 | 35 |
| D | 4 | 380.40 | 4 | 45 |

Step 3: Applying dynamic rules to select the most competitive product This step is to select the most competitive product by comparing several parameters. Each parameter is assigned a weight.
   Step 3.1: Finding the inverse price (ICP) of the product of each candidate seller shown in Table 2.
   Step 3.1.1: Finding MP, the maximum value of CPi
   For example, the MP of the products of the candidate sellers shown in Table 2 is 380.40.
   Step 3.1.2: Finding the inverse price (ICPi)
   The inverse price is defined as

ICPi=MP−Cpi
For example, the ICP values of the products of the candidate sellers (see Table 2) selected from Step 2 are:

TABLE 3
The ICP value

| Seller | CP | ICP = 380.40 − CP |
|---|---|---|
| A | 372.49 | 2.91 |
| B | 378.99 | 1.41 |
| C | 375.95 | 4.44 |
| D | 380.40 | 0 |

Step 3.2: Finding the price of the most competitive product, MCP. The present invention uses the model of representing a product's parameters as the coordinates of a point in a multi-dimensional space. Each parameter corresponds to one coordinate of a point. There are two issues that need to be resolved to be able to use this model:
   Since customers consider some of the parameters of a product inversely, the present invention introduces the concept of “inverse” to make all the parameters consistent. For example, the statement that a price is as low as possible is equivalent to the statement that the inverse price is as high as possible.
      Following this definition, we can have an updated list of customer's expectation:
      The inverse price of the product is as high as possible.
      The feedback rating given by the reviewer to the seller of the product is as high as possible.
      The number of reviewers to the seller of the product is as high as possible.
      The inverse page where a product appears in the search results is as late as possible.
Since not all the parameters are weighted equally, the present invention introduced the concept of “weighted point”. The coordinates of a point assigned different weights. This concept allows the present invention to assign different weights to different parameters of a product. For example, if the price of a product plays more important role in selling the product than the feedback rating of the seller of the product, then the weight of a product's price should be higher than the feedback rating of the product's seller.
   By using inverse or weighted method, it can then be claimed that a product is more competitive if the point the product's parameters represent is farther from the origin of the space.

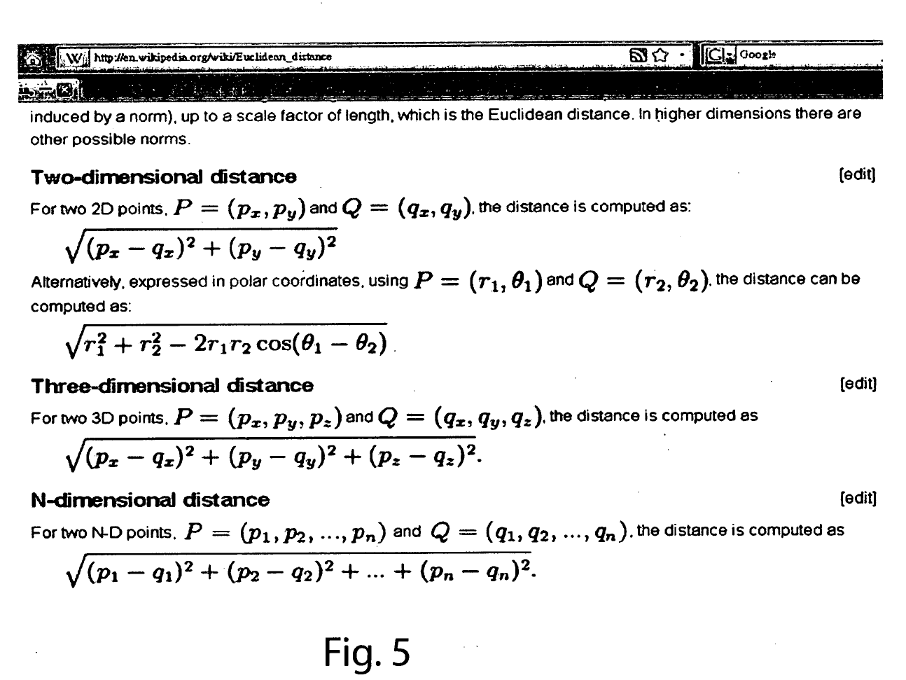

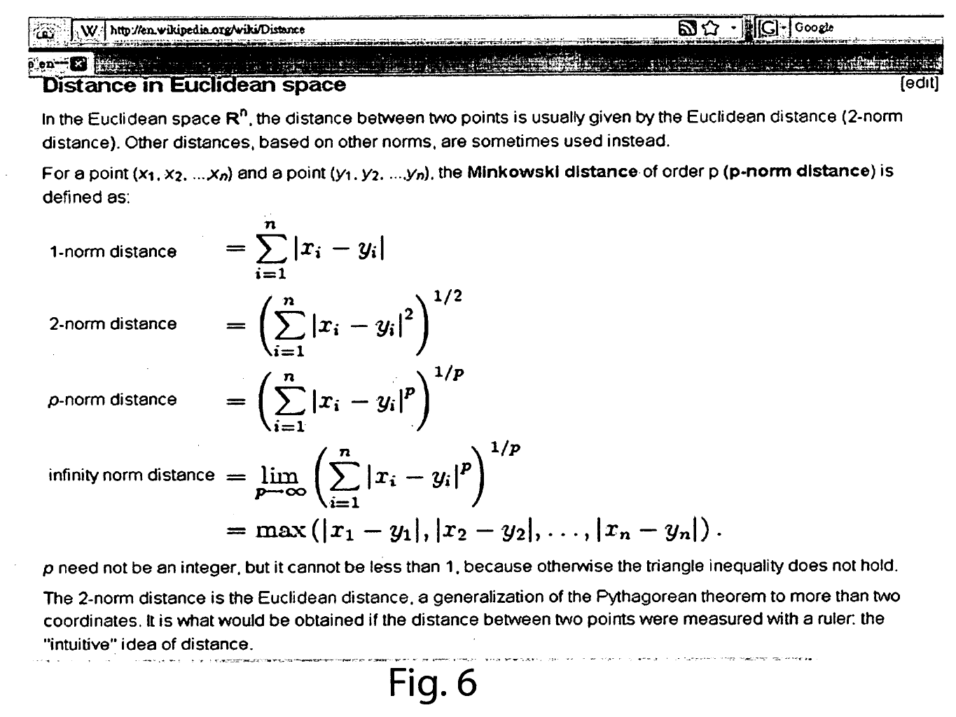

The present invention uses the Euclidean distance to compare the points to determine which competing product is the most competitive one. (Please refer to the website, http://en.wikipedia.org/wiki/Euclidean_distance referring to FIG. 5, for the definition of “Euclidean Distance.”) In the Euclidean space Rn, the distance between two points is usually given by the Euclidean distance (2-norm distance). Other distances, based on other norms, can also be used, which are defined as Minkowski distance as defined at the website, http://en.wikipedia.org/wiki/Distance referring to FIG. 6. For a point (x1, x2, . . . , xn) and a point (y1, y2, . . . , yn), the Minkowski distance of order p (p-norm distance) is defined as:

TABLE 4
Distance table

| | |
|---|---|
| 1-norm distance = | ${\sum }_{i = 1}^{n} \vert {x}_{i} - {y}_{i} \vert$ |
| 2-norm distance = | ${( {\sum }_{i = 1}^{n} {\vert {x}_{i} - {y}_{i} \vert}^{2} )}^{1 / 2}$ |
| p-norm distance = | ${( {\sum }_{i = 1}^{n} {\vert {x}_{i} - {y}_{i} \vert}^{p} )}^{1 / p}$ |
| infinity norm = | ${lim}_{p \to ∞} {( {\sum }_{i = 1}^{n} {\vert {x}_{i} - {y}_{i} \vert}^{p} )}^{1 / p}$ |
| distance = | max(\|x₁ − y₁\|, \|x₂ − y₂\|, . . . , \|xₙ − yₙ\|). |

p needs not be an integer, but it cannot be less than 1, because otherwise the triangle inequality does not hold. Other distance formulas that can be used to calculate the distance between two points are included but not be limited to Mahalanobis distance, Lee distance, Chebyshev distance, or Manhattan distance.

Using the model of representing a product's parameters as the coordinates of a point in a multi-dimensional space, the price of the most competitive product is the CPi that maximizes the value Score where Score is defined as:

Score=sqrt((ICPi*WICP)̂2+(ARi*WAR)̂2+(NRi*WNR)̂2+(ISPi*WSP)̂2). sqrt(x) defined as a function computing the square root of the value x.

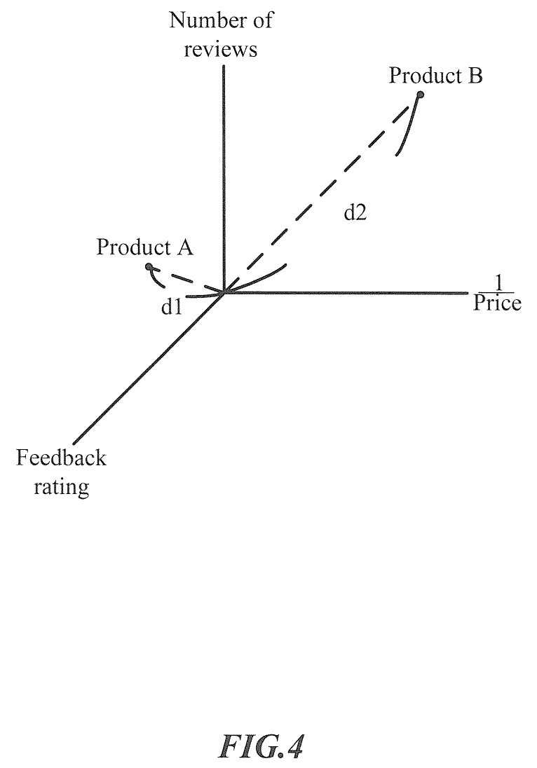

Referring to FIG. 4, it is an example of using three product's parameters as three axis in three dimensional space. As parameters increase, number of axis increases therefore extends to use multiple dimensions to present the data parameters. From the example in FIG. 4, since two of the parameters, feedback and reviewer, are the higher the better, whereas the price is the lower the better for customers. The price parameter axis is inversed so as the larger the price the smaller the inverse price will result. Inversed parameter method such as (1/price) or (predefined maximum price—price of product) can be used to achieve the inverse of original value. Therefore, the higher all three parameter values are the better for customers. By representing the three parameters in three-dimensional space, the product that is further away from the origin is the most competitive product. As shown in FIG. 4, product B has more competitive edge then product A. The way to define the axis can also change as well. By inversing the feedback and review parameter, (1/number of review), (1/feedback rating), (predefined maximum value−number of review) or (predefined maximum value−feedback rating), the lower all three parameter values are the better By representing the three parameters in three-dimensional space, the product that is closer to the origin is the most competitive product.

The following section is an example as shown in Table 2 to explain the model.

For example, if the weights are set as following equation.
The weight of the inverse price (WICP)=0.55
The weight of a seller's feedback rating (WAR)=0.25
The weight of the number of reviewers to a seller (WNR)=0.1
The weight of the inverse of the page where a product shows on a search result (WSP)=0.1

Then the price of the most competitive product can be found in this table:

TABLE 5
price of the competitive product

| | | | | Inverse | | | |
|---|---|---|---|---|---|---|---|
| | | Inverse | | Price | Feed- | | |
| | Page | of Page | | (ICP) = | back | Number of | |
| | num- | number | Price | 380.40 − | Rating | reviewers | |
| Seller | ber | (ISP) | (CP) | CP | (AR) | (NR) | Score |
| A | 1 | 4 | 372.49 | 2.91 | 4.5 | 30 | 3.59 |
| B | 2 | 3 | 378.99 | 1.41 | 4.5 | 40 | 4.23 |
| C | 3 | 2 | 375.95 | 4.44 | 3.5 | 35 | 4.36 |
| D | 4 | 1 | 380.40 | 0 | 4.0 | 45 | 4.61 |

From the above calculation, the most competitive seller is D. MCP is 380.40.

Step B: Process of determining the price of your product
The price of your product can be set in a way so that the combined score of your product is higher than the most competitive product's combined score. As a result, your product will outsell the most competitive product.

The following values will be used for an explanation.
Cost of your product (YC)=343.00
Markup percentage of your product (MU)=1.1
Markdown percentage of your product (MD)=0.9
Feedback rating of your company (ARy)=4.0
Number of reviewers of your company (NRy)=37
The page where your product shows up in a search result (Spy)=2
Step 4: Determining the upper limit of your product's price
This step is to calculate the upper limit of your product's price by comparing the price of the most competitive product found from Step A.
If (1) the score of the most competitive product is

SCOREx=sqrt((ICPx*WICP)̂2+(ARx*WAR)̂2+(NRx*WNR)̂2+(SPx*WSP)̂2)
(2) and your product's score is

SCOREy=sqrt((ICPy*WICP)̂2+(ARy*WAR)̂2+(NRy*WNR)̂2+(SPy*WSP)̂2)

Then the upper limit of ICPy can be determined in this way:

SCOREy>SCOREx

sqrt((ICPy*WICP)̂2+(ARy*WAR)̂2+(NRy*WNR)̂2+(ISPy*WSP)̂2)>SCOREx

(ICPy*WICP)̂2>(SCOREx)̂2−(ARy*WAR)̂2−(NRy*WNR)̂2−(ISPy*WSP)̂2

ICPy*WICP>sqrt((SCOREx)̂2−(ARy*WAR)̂2−(NRy*WNR)̂2−(ISPy*WSP)̂2)

ICPy>sqrt((SCOREx)̂2−(ARy*WAR)̂2−(NRy*WNR)̂2−(ISPy*WSP)̂2)/WICP

MP−CPy>sqrt((SCOREx)̂2−(ARy*WAR)̂2−(NRy*WNR)̂2−(ISPy*WSP)̂2)/WICP

CPy<MP−sqrt((SCOREx)̂2−(ARy*WAR)̂2−(NRy*WNR)̂2−(ISPy*WSP)̂2)/WICP

Thus,

CPy<380.40−sqrt(21.25−(4.0*0.25)̂2−(37*0.1)̂2−((4−2)*0.1)̂2)/0.55

CPy<380.40−sqrt(21.25−1−13.69−0.04)/0.55

CPy<380.40−sqrt(6.52)/0.55

CPy<380.40−2.55/0.55

CPy<380.40−4.63

CPy<75.77
Step 5: Determining the lower limit of your price, i.e., the minimum price you are willing to offer, MUP

$$\begin{matrix}MUP = YC * MU \\ = 320.00 * 1.1 \\ = 352.00\end{matrix}$$

Step 6: Determining the price marked down from the price of the most competitive product
This step is to determine how much less than the price of the most competitive product you are going to charge your product. This step is necessary if price is an important factor for customer's decision of buying a product. This is the formula to calculate the markdown price:

$$\begin{matrix}MDP = MCP * MD \\ = 375.77 * 0.98 \\ = 368.25\end{matrix}$$

Step 7: Computing the price of your product, CPy

```
If (MDP > MUP)
  {
CPy =MDP
  }
  else
  {
CPy =MUP
  }
```

What is claimed is:

1. A method for products re-pricing comprising steps:
searching all the competing sellers;
applying static rules to exclude unqualified competing sellers;
applying dynamic rules to select the most competitive product by finding the price of the most competitive product by using the model of representing a product's parameters as the coordinates of a point in a multi-dimensional space, each parameter corresponds to one coordinate of a point;
determining the upper limit of your product's price;
determining the lower limit of your price;
determining the markdown price of the price of the most competitive product;
compute the price of your product.

2. The method of claim 1, wherein finding the price of the most competitive product by assigning different weights to different parameters of a product.

3. The method of claim 1, wherein finding the price of the most competitive product by inversing different parameters of a product.

4. The method of claim 2, wherein finding the price of the most competitive product by inversing different parameters of a product.

5. The method of claim 1, wherein the distance between points in a multi-dimensional space uses the Euclidean distance to determine which competing product is the most competitive one.

6. The method of claim 1, wherein the distance between points in a multi-dimensional space uses the Minkowski distance to determine the most competitive product.

7. The method of claim 1, wherein the distance between points in a multi-dimensional space uses the Mahalanobis distance to determine the most competitive product.

8. The method of claim 1, wherein the distance between points in a multi-dimensional space uses the Lee distance to determine the most competitive product.

9. The method of claim 1, wherein the distance between points in a multi-dimensional space uses the Chebyshev distance to determine the most competitive product.

10. The method of claim 1, wherein the distance between points in a multi-dimensional space uses the Manhattan distance to determine the most competitive product.

11. The method of claim 3, wherein by inversing one or more parameters of a product, the product that is the closest to the origin on a multi-dimensional space marks the most competitive product.

12. The method of claim 3, wherein by inversing one or more parameters of a product, the product that is further away from the origin on a multi-dimensional space marks the most competitive product.

13. The method of claim 4, wherein by inversing and weighting one or more parameters of a product, the product that is the closest to the origin on a multi-dimensional space marks the most competitive product.

14. The method of claim 4, wherein by inversing and weighting one or more parameters of a product, the product that is further away from the origin on a multi-dimensional space marks the most competitive product.
